(19) United States
(12) Patent Application Publication
(10) Pub. No.: US 2019/0212263 A1
(43) Pub. Date: Jul. 11, 2019

(54) GRAPHENE-CONTAINING BIOSENSING CHIP AND DETECTION DEVICE COMPRISING THE BIOSENSING CHIP

(71) Applicant: NATIONAL TAIWAN NORMAL UNIVERSITY, Taipei City (TW)

(72) Inventors: NAN-FU CHIU, Taipei City (TW); Chia-Tzu KUO, Taipei City (TW)

(73) Assignee: NATIONAL TAIWAN NORMAL UNIVERSITY, Taipei City (TW)

(21) Appl. No.: 15/942,445

(22) Filed: Mar. 31, 2018

(30) Foreign Application Priority Data
Jan. 11, 2018 (TW) 107101085

(51) Int. Cl. G01N 21/552

(52) U.S. Cl. CPC G01N 21/554

(57) ABSTRACT

A graphene-containing biosensing chip includes a transparent substrate; a metal layer disposed on the transparent substrate; and a graphene layer disposed on the metal layer; wherein the graphene layer is amino (—NH2)-modified. The amino (—NH2)-modified graphene layer effectively enhances sensitivity of a detection device having the biosensing chip. The biosensing chip is applicable to detection of various biological molecules.

### CROSS-REFERENCE TO RELATED APPLICATION

This non-provisional application claims priority under 35 U.S.C. § 119(a) on Patent Application No(s). 107101085 filed in Taiwan, R.O.C. on Jan. 11, 2018, the entire contents of which are hereby incorporated by reference.

### FIELD OF THE INVENTION

The present invention relates to biosensing chips and, more particularly, to a graphene-containing biosensing chip. The present invention further relates to a detection device comprising the biosensing chip.

### BACKGROUND OF THE INVENTION

Conventional biological detection techniques involve performing ELISA to study protein specificity. Despite its technological sophistication and findings well recognized among biologists, ELISA requires fluorescent dyes which complicate ELISA. In view of this, it is important to develop novel biosensors.

The tiny sizes of the targets to be sensed by immunoassay biochips which detect biological molecules or sensing chips which detect gas concentration are nowadays reduced to microscale or even nanoscale. Hence, system sensitivity is a key index of competitiveness and reliability of sensors and applications thereof.

Gas and biological molecules detection devices, which involve applying conducting metal oxide nano film to biomedical sensing systems and detecting by surface plasmon resonance (SPR) as to how well specific biological molecules or gas molecules in micro-channels on surfaces of biomedical chips are bound to the chips, are highly sensitive, reliable and practical as well as widely applicable to future development of multichannel, high-throughput detection and high-sensitivity portable instruments, with a view to achieving high sensitivity and high throughput.

In this regard, SPR has advantages as follows: asking no standardization, attaining instant high throughput, and assaying the molecular affinity between a subject under test and biological molecules with just a trace amount of samples to collect quantifiable information about dynamics of intermolecular reactions and thereby serve the purpose of drug discovery instruments or in vitro diagnostics (IVDs).

U.S. Pat. No. 7,671,995 B2 discloses an apparatus of detecting biochemical molecules and gases by using a surface plasmon resonance (SPR) molecular sensing technology, comprising: a coupler; a sensor chip; a cavity space, provided for a reaction of testing molecules; a detector; and an incident light source; wherein the sensor chip further comprises at least one layer of transparent substrate, at least one layer of conducting metal oxide intermediate layer and at least one layer of metal thin film layer.

TW I304707 discloses an organic electroluminescence surface plasmon resonance-based sensing device, comprising: an organic electroluminescence component for providing an excitation source of surface plasmon resonance wave; an insulating layer positioned proximate to a cathode layer of the organic electroluminescence component; and a sensing layer for sensing a target substance, with the sensing layer positioned proximate to the insulating layer or positioned proximate to a substrate of the organic electroluminescence component.

### SUMMARY OF THE INVENTION

Conventional biological detection devices which operate by surface plasmon resonance technology still have room for improvement in sensitivity. Therefore, it is an objective of the present invention to provide a biosensing chip conducive to enhancement of the sensitivity of a detection device comprising the biosensing chip.

In order to achieve the above and other objectives, the present invention provides a biosensing chip, comprising:
a transparent substrate;
a metal layer disposed on the transparent substrate; and
a graphene layer disposed on the metal layer;
wherein the graphene layer is amino (—NH₂)-modified.

In an embodiment of the present invention, the graphene layer comprises graphene oxide and/or reduced graphene oxide.

In an embodiment of the present invention, the transparent substrate is glass substrate, silicon substrate or polymer substrate.

In an embodiment of the present invention, the polymer substrate is polyethylene (PE) substrate, polyvinyl chloride (PVC) substrate, polyethylene terephthalate (PET) substrate, polydimethylsiloxane (PDMS) substrate or poly(methyl methacrylate) (PMMA) substrate.

In an embodiment of the present invention, the metal layer comprises gold, silver, platinum, palladium, copper or aluminum.

In an embodiment of the present invention, the metal layer comprises:
a chromium film or a titanium film disposed on the transparent substrate; and
a gold film disposed on the chromium film or the titanium film.

In an embodiment of the present invention, the gold film is of a thickness of 20 nm˜60 nm.

In an embodiment of the present invention, the chromium film or the titanium film is of a thickness of 1 nm˜5 nm.

In order to achieve the above and other objectives, the present invention provides a detection device, comprising:
the biosensing chip of the present invention;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

In an embodiment of the present invention, the emission source emits electromagnetic wave with a wavelength of 400 nm˜1500 nm.

In an embodiment of the present invention, the emission source emits laser with a wavelength of 690 nm.

In an embodiment of the present invention, the emission source emits electromagnetic wave to the biosensing chip at an angle of incidence of 30° to 80°.

In an embodiment of the present invention, the emission source emits electromagnetic wave to the biosensing chip at an angle of incidence of 40° to 60°.

Compared with conventional biosensing chips, the biosensing chip of the present invention features an amino (—NH₂)-modified graphene layer and thus enhances the sensitivity of a detection device comprising the biosensing chip.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a biosensing chip of the present invention;

FIG. 2 is a schematic view of the process flow of chlorine substitution-based modification of Production Example 1-2;

FIG. 3 is a graph of angle against time, showing molecular dynamic reactions between peptide ((N-)PPLRINRHILTR(-C)) and a material, as detected at different flow rates;

FIG. 4 is a graph of angle against time, showing test results of reactions between the biosensing chip and peptide at a flow rate of 30 μl/min in Embodiment 1-2 and Comparison Example 1;

FIG. 5 is a graph of angle against time, showing test results of different specimens not mixed;

FIG. 6 is a graph of angle against time, showing test results of disruptors for HAS and BSA of mix concentration of 20 nM in recombinant protein;

FIG. 7 is a linear regression analysis diagram of FIG. 5 and FIG. 6;

FIG. 8 is a graph of angle against time, showing test results of non-immunogenic proteins of the biosensing chip of (GO-NH₂) in Embodiment 1-2;

FIG. 9 is a graph of angle against time, showing test results of non-immunogenic proteins of the biosensing chip of (GO-COOH) in Comparison Example 1;

FIG. 10 is a graph of angle against time, showing test results of non-immunogenic proteins of a conventional biosensing chip;

FIG. 11 is a linear regression analysis diagram of FIG. 8, FIG. 9 and FIG. 10; and

FIG. 12 is a schematic view of a detection device of the present invention.

### DETAILED DESCRIPTION OF THE PREFERRED EMBODIMENTS

Related layers shown in the drawings of the present invention are adjusted, omitted or simplified in terms of thickness or size for the sake of illustration and clarity. Regarding related components, the drawings of the present invention are not drawn to scale.

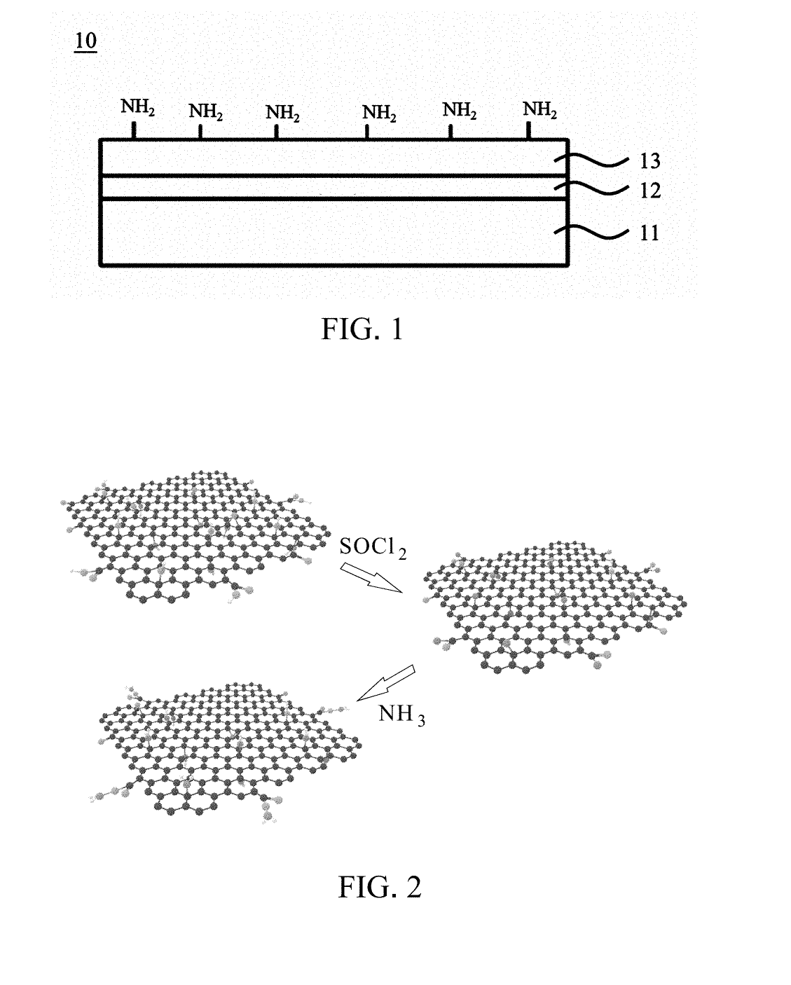

Referring to FIG. 1, a biosensing chip 10 of the present invention comprises a transparent substrate 11; a metal layer 12 disposed on the transparent substrate; and a graphene layer 13 disposed on the metal layer; wherein the graphene layer is amino (—NH₂)-modified.

### PRODUCTION EXAMPLE 1

### Amino-Modified Graphene Oxide (GO-NH₂) and/or Reduced Graphene Oxide (rGO-NH₂)

The biosensing chip of the present invention comprises an amino-modified graphene layer. To form the graphene layer, it is feasible to produce an amino-modified graphene oxide (GO) and/or reduced graphene oxide (rGO) aqueous solution by the method of Production Examples 1-1, 1-2 and 1-3 described below, but the present invention is not limited thereto.

### PRODUCTION EXAMPLE 1-1

### Chemical Bonding-Based Modification

Chemical bonding-based modification replies upon intuition. For instance, Cho et al. (S. Cho, J. S. Lee, and J. Jang, “Poly(vinylidene fluoride)/NH₂-Treated Graphene Nanodot/Reduced Graphene Oxide Nanocomposites with Enhanced Dielectric Performance for Ultrahigh Energy Density Capacitor,” ACS Appl. Mater. Interfaces, 2015, 7, 9668-9681.) put forth introducing ethylenediamine (EDA) with two ends carrying amino groups into a graphene oxide (GO) solution to enable the GO surface to have some exposed amino groups because of the covalent bonding of each amino group and a carboxyl group, but leading to drawbacks as follows: owing to sole use of chemical bonding of surface groups, there is no significant change in the structural and optical characteristics of the GO. Owing to the low carboxyl group content of the oxygen group of GO, there are few modifying amino groups, and the process flow of the reaction is expressed by formula (A) below.

Chen et al. (W.-Q. Chen, Q.-T. Li, P.-H. Li, Q.-Y. Zhang, Z.-S. Xu, P.-K. Chu, X.-B. Wang, and C.-F. Yi, “In Situ Random Co-polycondensation for Preparation of Reduced Graphene Oxide/Polyimide Nanocomposites with Amino-modified and Chemically Reduced Graphene Oxide,” J. Mater. Sci., 2015, 11, 3860-3874) proposes that a reaction between (3-aminopropyl) trimethoxysilane (APTES) and hydroxyl groups of GO surface is followed by silane bonding through GO and silicon atoms of APTES. Y, Lin, J, Jina, and M. Song, “Preparation and characterisation of covalent polymer functionalized graphene oxide” J. Mater. Chem., 2011, 21, 3455-3461, proposes that the GO surface has exposed amino groups, and the process flow of the reaction is expressed by formula (B).

### PRODUCTION EXAMPLE 1-2

### Chlorine Substitution-Based Modification

The process flow of the reaction in Production Example 1-2 is illustrated by FIG. 2.

Chlorine substitution-based modification involves effecting a reaction by the oxygen atom of a hydroxyl group of GO surface and highly active thionyl chloride (SClO₂) (M. B. Smith, and J. March, Advanced Organic Chemistry: Reactions, Mechanisms, and Structure (New York: Wiley-Interscience, 2007)) such that the hydroxyl group is replaced with a chlorine atom, and its reaction mechanism is expressed by formula (C) below.

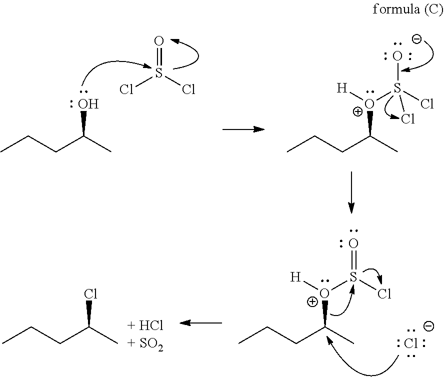

Then, the GO surface reacts with caustic ammonia such that the chlorine atom is replaced with an amino group, thereby allowing the GO surface to be modified with a huge amount of amino groups (W. Hou, B. Tang, L. Lu, J. Sun, J. Wang, C. Qin, and L, Dai, “Preparation and Physico-mechanical Properties of Amine-functionalized Graphene/Polyamide 6 Nanocomposite Fiber as a High Performance Material,” RSC Adv., 2014, 4, 4848.) Its reaction mechanism is expressed by formula (D) below (wherein R₁ denotes GO).

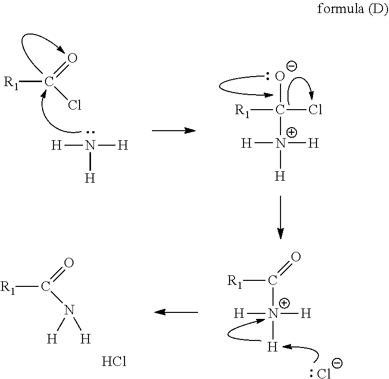

### PRODUCTION EXAMPLE 1-3

### Hydrothermal Synthesis Modification

Hydrothermal synthesis modification is put forth by Lai et al. (L. Lai, L. Chen, D. Zhan, L. Sun, J. Liu, S. H. Lim, C. K. Poh, Z. Shen, and J. Lin, “One-step Synthesis of NH₂-graphene from In Situ Graphene-oxide Reduction and Its Improved Electrochemical Properties,” Carbon, 2011, 49, 3250-3257), proposing that GO, ethylene glycol solution and caustic ammonia undergo a reaction at high temperature (around 160° C.) and high pressure in a hydrothermal synthesis kettle which is heated up so as to allow amino groups to substitute for various groups, such as the hydroxyl group, epoxy group, and carbonyl group, in the GO. Since a high temperature reaction inevitably leads to reduction of non-amino-modified oxygen group, a portion of the GO is turned into reduced graphene oxide (rGO). With hydrothermal synthesis modification, the GO is modified with amino groups only. For example, Guan et al. (S. K. Singh, M. K. Singh, P. P. Kulkarni, V. K. Sonkar, J. J. A. Gracio, and D. Dash, “Amine-Modified Graphene: Thrombo-Protective Safer Alternative to Graphene Oxide for Biomedical Applications,” ACS NANO, 2012, 6, 2731-2740) proposes modifying the GO with an amino-containing compound with different carbon chain lengths by methylamine (CH₃NH₂) and n-Butylamine (ⁿBuNH).

Results of comparison of modification methods in Production Example 1 are shown in Table 1 below.

TABLE 1

| modification | | |
|---|---|---|
| method | applicable material | feature |
| chlorine | thionyl chloride | Highly active chlorine substi- |
| substitution-based | (SClO₂), | tutes for original oxygen group |
| modification | caustic ammonia | of graphene oxide, and then an |
| | | amino group substitutes for |
| | | chlorine element, but caustic |
| | | ammonia also causes reduction. |
| hydrothermal | ethylene glycol, | The bonding of an amino group |
| synthesis | caustic ammonia | and graphene oxide occurs at |
| modification | | high temperature and high pres- |
| | | sure. This method also causes |
| | | reduction of graphene oxide. |
| hydroxyl-based | (3-aminopropyl) | Graphene oxide surfaces are full |
| modification | trimethoxysilane | of amino groups because of |
| | (APTES) | silane bonding. Since the ele- |
| | | ment which bonds with the |
| | | carbon atom remains unchanged, |
| | | there is little modification of |
| | | characteristics of graphene. |
| carboxyl- | ethylenediamine | The covalent bonding of an |
| modified | (EDA) | amino group and carboxyl group |
| | | causes graphene oxide surfaces |
| | | to have some exposed amino |
| | | groups. However, the carboxyl |
| | | group content of graphene oxide |
| | | is so low that this method only |
| | | enables graphene oxide surfaces |
| | | to have few amino groups. |

### PRODUCTION EXAMPLE 2

### Bare Au Chip

The biosensing chip of the present invention comprises: a transparent substrate; and a metal layer disposed on the transparent substrate. The transparent substrate and the metal layer are for use in producing a bare Au chip in Production Example 2 as described below.

The production process of the bare Au chip in Production Example 2 involves using BK7 glass (18×18 mm, 175 μm) as the transparent substrate, plating BK7 glass with a chromium (Cr) layer of a thickness of 2 nm by an evaporation system, and then plating BK7 glass with a gold (Au) layer of a thickness of 47 nm, so as to form a bare Au chip with a metal layer comprising a chromium film and a gold film. Afterward, the bare Au chip undergoes acetone ultrasonic vibration for 3 minutes, isopropyl alcohol ultrasonic vibration for 3 minutes, and deionized water (D. I. water) ultrasonic vibration for 3 minutes sequentially for surface cleaning, and then the chip surface is dried with a nitrogen gas current.

In Production Example 2, the chromium film serves to enhance adhesiveness of the gold film, but the present invention is not limited thereto. The step of plating chromium may be dispensed with such that the transparent substrate is directly plated with a precious metal (i.e., gold, silver, platinum, or palladium), copper or aluminum. In a variant embodiment, a titanium film substitutes for the chromium film.

In Production Example 2, BK7 glass functions as a transparent substrate, but the present invention is not limited thereto, and thus any other conventional transparent substrate is applicable to the present invention. For example, the transparent substrate is glass substrate, silicon substrate or polymer substrate (such as polyethylene (PE) substrate, polyvinyl chloride (PVC) substrate, polyethylene terephthalate (PET) substrate, polydimethylsiloxane (PDMS) substrate or poly(methyl methacrylate) (PMMA) substrate).

In Production Example 2, the gold film is of a thickness of 47 nm such that surface plasmon resonance is optimal at an incident wavelength of 690 nm, but the present invention is not limited thereto. Preferably, the gold film has a thickness of 20 nm˜60 nm. Preferably, the chromium film has a thickness of 1 nm˜5 nm.

### Embodiment 1: Amino-Modified Graphene Oxide Chip (GO-NH₂ Chip)

### Embodiment 1-1

500 μL of 5 mM cystamine (Cys) solution is transported to the surface of the bare Au chip of Production Example 2 with a pipette and then stands still for 24 hours. Afterward, the chip surface is cleaned with deionized water and then dried with a nitrogen spray gun, so as to form a Au/Cys chip. Afterward, 500 μL of 0.5 mg/mL GO-NH₂ aqueous solution of Production Example 1-2 is transported to the Au/Cys chip surface with the pipette and stands still for 5 hours. Afterward, the chip surface is cleaned with deionized water and then dried with a nitrogen spray gun, so as to finalize the production of the biosensing chip in Embodiment 1-1.

### Embodiment 1-2

Embodiment 1-2 is substantially identical to Embodiment 1-1 in terms of the production process of the biosensing chip, except that the concentration of the GO-NH₂ aqueous solution of Embodiment 1-2 is different from that of Embodiment 1-1, that is, 1 mg/mL.

### Embodiment 2: Amino-Modified Reduced Graphene Oxide Chip (rGO-NH₂ Chip)

### Embodiment 2-1

500 μL of 5 mM cystamine (Cys) solution is transported to the surface of the bare Au chip of Production Example 2 with the pipette and stands still for 24 hours Afterward, the chip surface is cleaned with deionized water and then dried with a nitrogen spray gun, so as to form a Au/Cys chip. Then, 500 μL of 0.5 mg/mL rGO-NH₂ aqueous solution of Production Example 1-3 is transported to Au/Cys chip surface with the pipette and stands still for 5 hours. Afterward, the chip surface is cleaned with deionized water and then dried with a nitrogen spray gun, so as to finalize the production of the biosensing chip in Embodiment 2-1.

### Embodiment 2-2

Embodiment 2-2 is substantially identical to Embodiment 2-1 in terms of the production process of the biosensing chip, except that the concentration of the rGO-NH₂ aqueous solution of Embodiment 2-2 is different from that of Embodiment 2-1, that is, 1 mg/mL.

Both Embodiment 1 and Embodiment 2 involve fixing a graphene layer to a metal layer surface by a chemical linker provided in the form of cystamine (Cys), but the present invention is not limited thereto, and thus any other compound, for example, cysteamine (CA), 8-mercaptooctanoic acid (8-MOA), 6-mercaptohexanoic acid (6-MHA), captopropionic acid (3-MPA) and octadecanethiol (ODT), may function as a linker.

In addition to the chemical linker, the graphene can be fixed to the metal layer surface by physical and chemical methods well known among persons skilled in the art as follows:
Adsorption: the graphene molecules are physically fixed to the metal layer surface by hydrophilicity, hydrophobicity and charging, such as electrostatic forces, π-π stacking, and van der Waals forces. Electrostatic forces which originate from the metal layer surface are enhanced by oxygen plasma (O₂ plasma) or UV-ozone (O₃).
Covalent bonding: covalent bonding is effectuated by activating a group on the graphene molecule and a specific group of the metal layer surface.
Entrapment: graphene is enclosed by a thin-film coated on the metal layer surface.
Cross-linking: like entrapment, cross-linking involves using a crosslinking agent to form a three-dimensional structure as a result of a reaction between the crosslinking agent and the thin-film on the metal layer surface.
Biological binding: graphene and the metal layer surface are bound together by active biological molecules of specificity.

### Comparison Example 1: Carboxyl-Modified Graphene Oxide Chip (GO-COOH Chip)

In Comparison Example 1, graphene oxide chip forms carboxyl-modified graphene oxide by chloroacetic acid modification. The carboxyl-modified graphene oxide thus formed is known as GO-COOH standard material.

Chloroacetic Acid Modification: 1.2 g of NaOH and 1 g of chloroacetic acid (Cl—CH2—COOH) are added to 2 mg/mL GO aqueous solution before the mixture undergoes water bath ultrasonic vibration for three hours; then, the mixture is filtered repeatedly, and the resultant solid is carboxyl-modified graphene oxide (GO-COOH standard material) (X. Sun, Z. Liu, K. Welsher, J. T. Robinson, A. Goodwin, S. Zaric, and H. Dai, “Nano-Graphene Oxide for Cellular Imaging and Drug Delivery,” Nano Res., 2008, 1, 203-212.)

500 μL of 5 mM cystamine (Cys) solution is transported to the surface of the bare Au chip of Production Example 2 with the pipette and stands still for 24 hours Afterward, the chip surface is cleaned with deionized water and then dried with a nitrogen spray gun, so as to form a Au/Cys chip. Then, 500 μL of 1 mg/mL GO-COOH aqueous solution produced by the chloroacetic acid modification is transported to Au/Cys chip surface with the pipette and stands still for 5 hours. Afterward, the chip surface is cleaned with deionized water and then dried with a nitrogen spray gun, so as to finalize the production of the biosensing chip in Comparison Example 1.

Carboxyl-modified graphene oxide is produced by oxalic acid modification too.

Oxalic Acid Modification: 5 ml of HBr is introduced into GO (2.5 mg/mL, 30 mL) dissolved in superpure water; stir the mixture for 12 hours to allow part of the epoxy to turn into a hydroxyl group (S. Pei, J. Zhao, J. Du, W. Ren, H.-M. Cheng, “Direct reduction of Graphene Oxide Films into Highly Conductive and Flexible Graphene Films by Hydrohalic Acids,” Carbon, 48, 2010, 4466-4474); add 1.5 g of oxalic acid (C2H2O4) to the mixture and stir the mixture for four hours such that oxalic acid binds with the hydroxyl group, releasing a water molecule; then, filtration is performed, and the product is dried at 50° C. in a vacuum for 24 hours; the result solid is dissolved in the water in a required proportion. (Y. Liu, R. Deng, Z. Wangab, and H. Liu, “Carboxyl-functionalized Graphene Oxide-polyaniline Composite as A Promising Supercapacitor Material,” J. Mater. Chem., 2012, 22, 13619.)

### Test Example 1: Biological Experiment

Phosphate buffered saline (PBS) with a flow rate of 30 μl/min serves as an ambient solution. 200 μl of samples of a micro-channels system is introduced into the PBS by BI-3000G (Biosensing Instrument, Tempe, Ariz., USA) while being exposed from the biosensing chip surface of Embodiment 1-2 for 200 seconds. The surface groups are activated by 1-ethyl-3-(3-dimethylaminopropyl)carbodiimide (EDC) (400 mM) and n-hydroxysuccinimide (NHS) (100 mM). Then, peptide ((N-)PPLRINRHILTR(-C) (N-Pro-ProLeu-Arg-Ile-Asn-Arg-His-Ile-Leu-Thr-Arg-C)) (Nan-Fu Chiu, Chia-Tzu Kuo, Ting-Li Lin, Chia-Chen Chang, Chen-Yu Chen, Ultra-high sensitivity of the non-immunological affinity of graphene oxide-peptide based surface plasmon resonance biosensors to detect human chorionic gonadotropin, Biosens Bioelectron 94 (2017) pp. 351-357. (http://www.sciencedirect.com/science/article/pii/S0956566317301628?via %3D ihub); Ding, X., and Yang, K.-L., 2013. Antibody-free detection of human chorionic gonadotropin by use of liquid crystals. Anal. Chem., 85, 10710-10716) is introduced to the surface of the biosensing chip of Embodiment 1-2 such that it binds with GO-NH2 on the chip surface. To confirm its specificity reaction, unbound groups on the chip surface are covered with ethyl acetate (EA) (1 M), and then non-covalent bonding molecules are removed from the chip surface by NaOH (10 mM). Afterward, human chorionic gonadotropin (hCG) of different concentrations are introduced, whereas targets of different concentrations are also removed by NaOH (10 mM).

### Test Example 1-1: Flow Rate Experiment

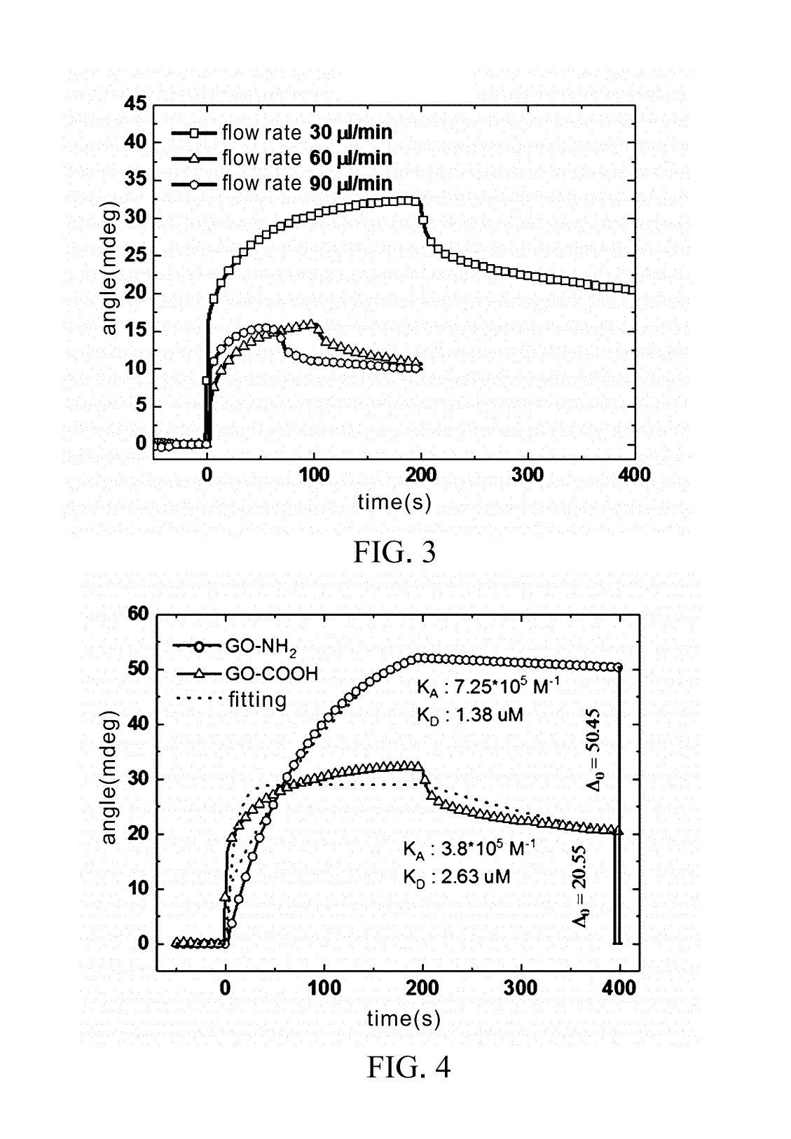

FIG. 3 is a graph of angle against time, showing molecular dynamic reactions between peptide ((N-)PPLRINRHILTR(-C)) and a material, as detected at different flow rates.

In the peptide sensing experiment on the GO-COOH standard material, with the peptide molecule much smaller than antibodies, there is no significant changes in the quality of resultant refraction. To confirm a fixed peptide probe and enhance sensing sensitivity, Test Example 1-1 detects differences in affinity and reaction quantity between a modified material and the peptide probe at different flow rates and finds that the reaction quantities are similar (around 12 mdeg) at a flow rate of 60 and 90 μl/min, whereas the reaction quantities increase greatly (to around 21 mdeg) because of an increased duration of contact and high probability of bombardment when the flow rate is reduced to 30 μl/min. Therefore, standard sample experiments always require an ambient flow rate of 30 μl/min and entail comparing different materials and different specimens concentrations for reactions at SPR resonant angle and effectuating clinical serum detection.

### Test Example 1-2: Material and Peptide Affinity Reaction Comparison Experiment

FIG. 4 is a graph of angle against time, showing test results of reactions between the biosensing chip and peptide at a flow rate of 30 μl/min in Embodiment 1-2 and Comparison Example 1.

The gold film surface is modified with different materials at a flow rate of 30 μl/min. A comparison of Embodiment 1-2 (GO-NH₂) biosensing chip and Comparison Example 1 (GO-COOH) biosensing chip in terms of resonant angle reaction quantity shows that Embodiment 1-2 (GO-NH₂) biosensing chip reacts with peptide, by a quantity and at KA value, greater than Comparison Example 1 (GO-COOH) biosensing chip by 2.45 times and 1.91 times, respectively, proving that GO-NH₂ material has higher affinity toward peptide than GO-COOH does, discovering that GO-COOH surface forms more non-specific bonds. Hence, when a channel environment change to an ambient solution, angular decrease is abrupt. Owing to a large number of fixed peptide probes, more target molecules are retrieved at the same concentration, thereby bringing increasingly vigorous refraction quality changes which in turn provides higher sensitivity.

### Test Example 1-3: Recombinant Protein Mix Disruptor Experiment

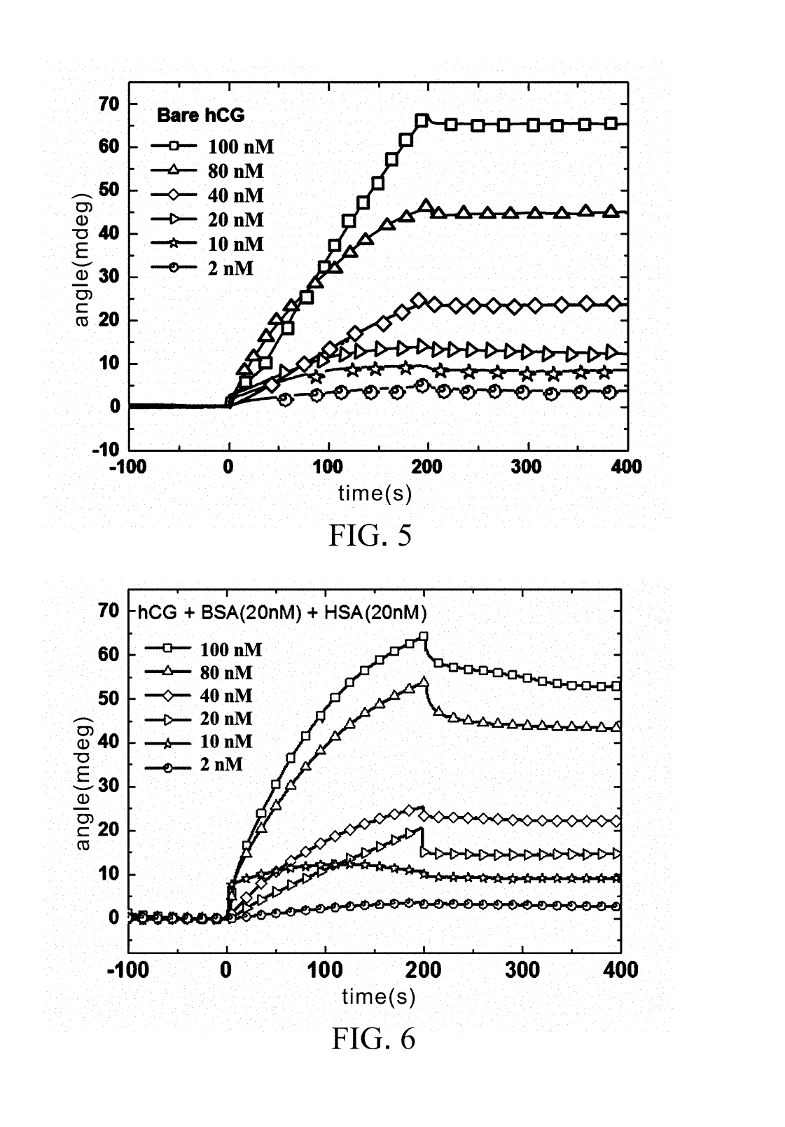

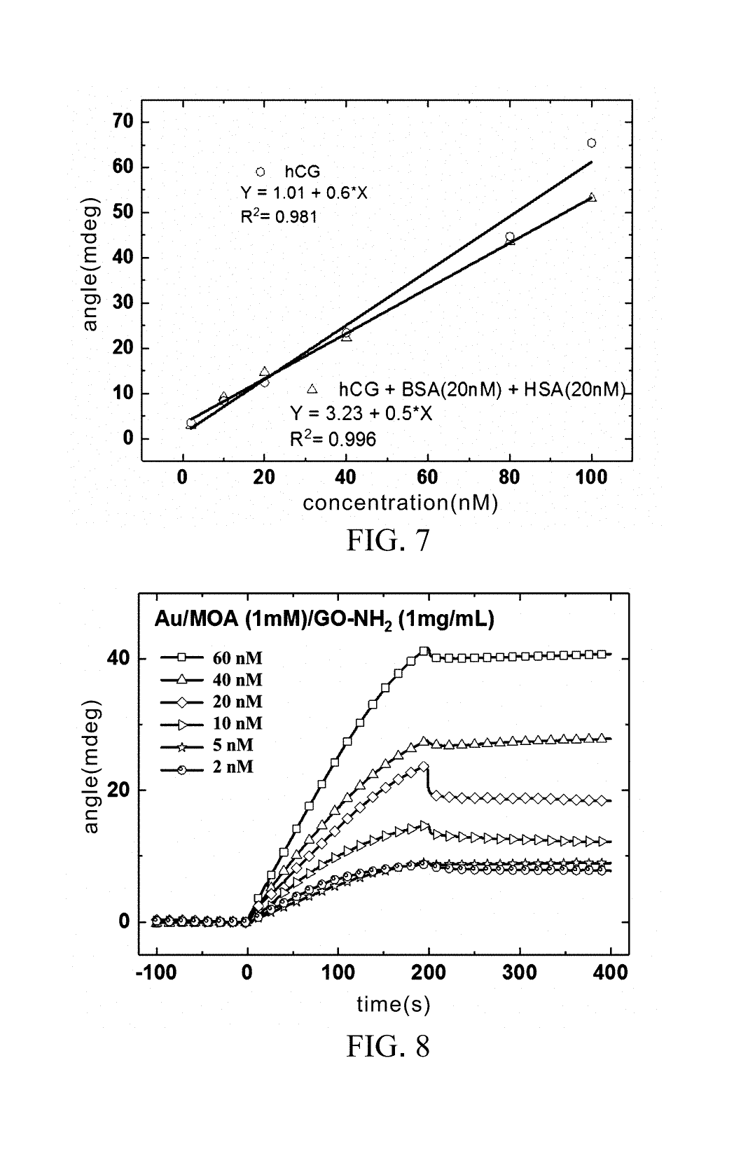

FIG. 5 is a graph of angle against time, showing test results of different specimens not mixed. FIG. 6 is a graph of angle against time, showing test results of disruptors for HAS and BSA of mix concentration of 20 nM in recombinant protein. FIG. 7 is a linear regression analysis diagram of FIG. 5 and FIG. 6.

Before comparing the reaction between different materials, Test Example 1-3 involves measuring the specificity of peptide by fixing peptide to GO-COOH standard material modification chip, performing reaction detection, adding 20 nM BSA and HAS to hCG specimens, and observing reaction results. As shown in FIG. 5 and FIG. 6 which illustrate tests of reaction quantity, the introduction of disruptors not only affects the reaction diagrams but also has no effect on the reaction results. As shown in FIG. 7, a linear regression analysis diagram reveals that no disruption is caused by concentration change except for high concentration (100 nM). It is because, at high concentration, part of the hCG has a reduced chance of bombardment in the presence of disruptors, which in turn leads to increased non-specific adsorption, thereby decreasing SPR angle reaction. As shown in FIG. 6, the curve at a concentration of 100 nM reveals maximum non-specific dissociation reaction after contact. Therefore, the subsequent experiments are focused on linear analysis conducted at concentration which ranges from 2 nM to 80 nM. Furthermore, Test Example 1-3 proves that peptide manifests excellent specificity toward hCG.

Test Example 1-4: Experiment on Analysis of How Different Chips React with Recombinant Protein and Peptide

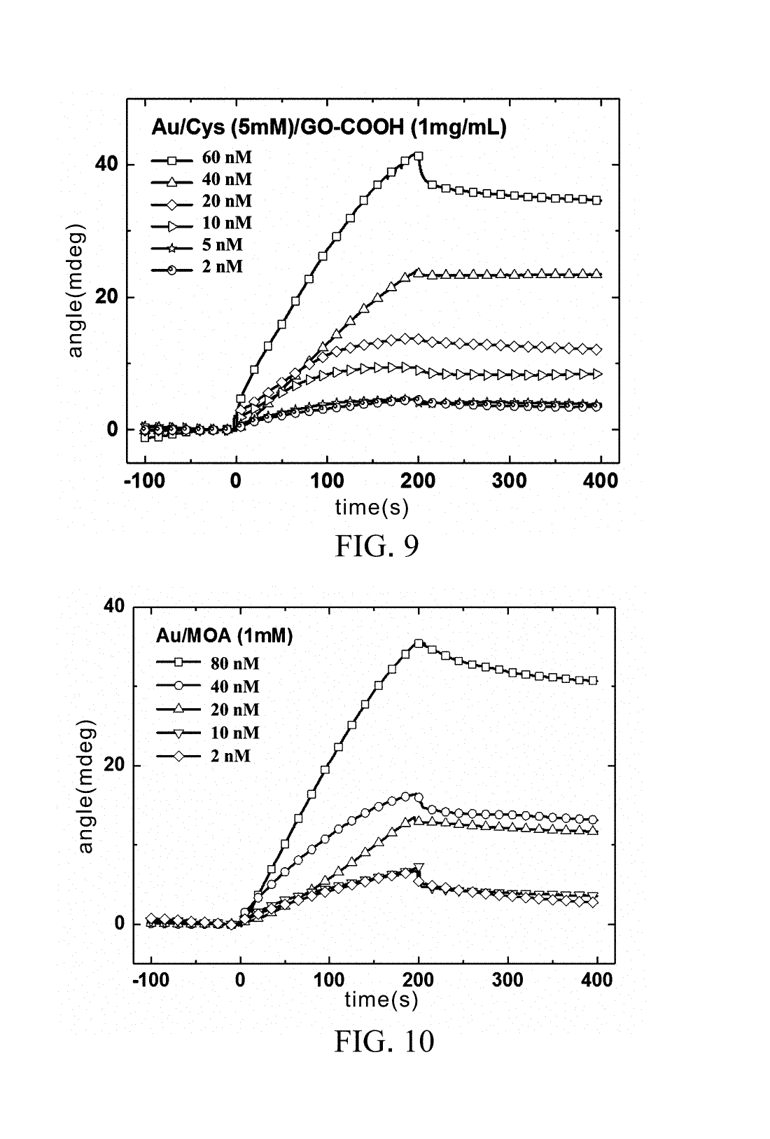

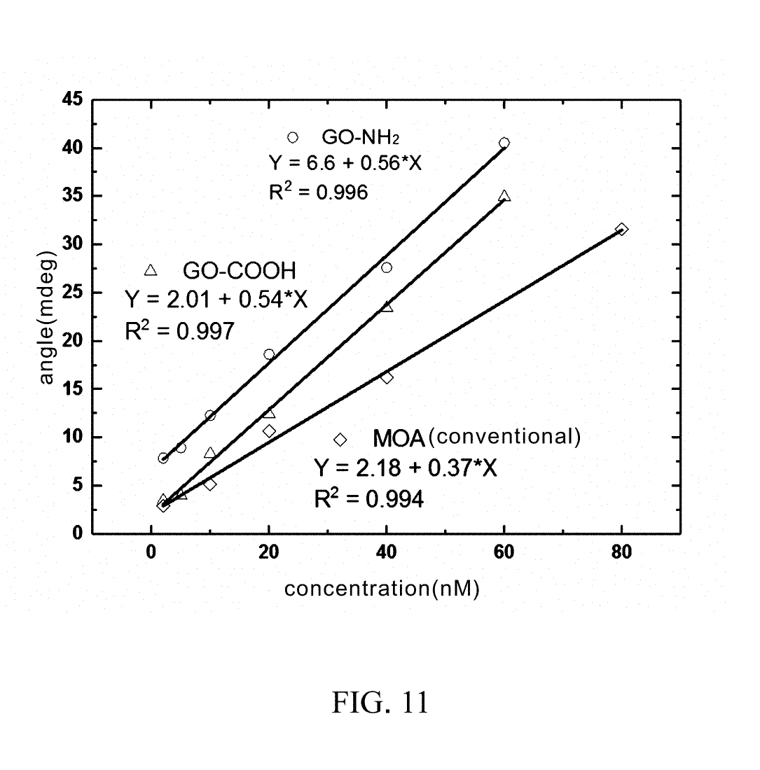

FIG. 8 is a graph of angle against time, showing test results of non-immunogenic proteins of the biosensing chip of (GO-NH₂) in Embodiment 1-2. FIG. 9 is a graph of angle against time, showing test results of non-immunogenic proteins of the biosensing chip of (GO-COOH) in Comparison Example 1. FIG. 10 is a graph of angle against time, showing test results of non-immunogenic proteins of a conventional biosensing chip, that is, MOA chip (Biacore standard chip). FIG. 11 is a linear regression analysis diagram of FIG. 8, FIG. 9 and FIG. 10.

Test Example 1-4 involves measuring different concentrations of hCG with three different biochips. FIG. 8 shows the test results of Embodiment 1-2 (GO-NH₂) biosensing chip and reveals that Embodiment 1-2 (GO-NH2) biosensing chip has a slightly greater reaction quantity than Comparison Example 1 (GO-COOH) biosensing chip (as shown in FIG. 9) and surpasses conventional sensing chips (as shown in FIG. 10). The linear regression analysis illustrated by FIG. 11 shows that both Embodiment 1-2 (GO-NH₂) biosensing chip and Comparison Example 1 (GO-COOH) biosensing chip have a greater slope than conventional sensing chips by around 1.513 times, because graphene materials enhance coupling efficiency, which in turn enhances sensitivity. Hence, a great displacement angle arises from specimens of the same concentration and the same refraction variation. FIG. 11 further reveals that Embodiment 1-2 (GO-NH₂) biosensing chip and Comparison Example 1 (GO-COOH) biosensing chip have similar linear regression slopes, though Embodiment 1-2 (GO-NH₂) biosensing chip has greater reaction quantity than Comparison Example 1 (GO-COOH) biosensing chip, because GO-NH₂ has higher affinity toward peptide than GO-COOH; hence, more hCG is retrieved from specimens of the same concentration, so as to attain greater refraction variation.

### Embodiment 3: Detection Device

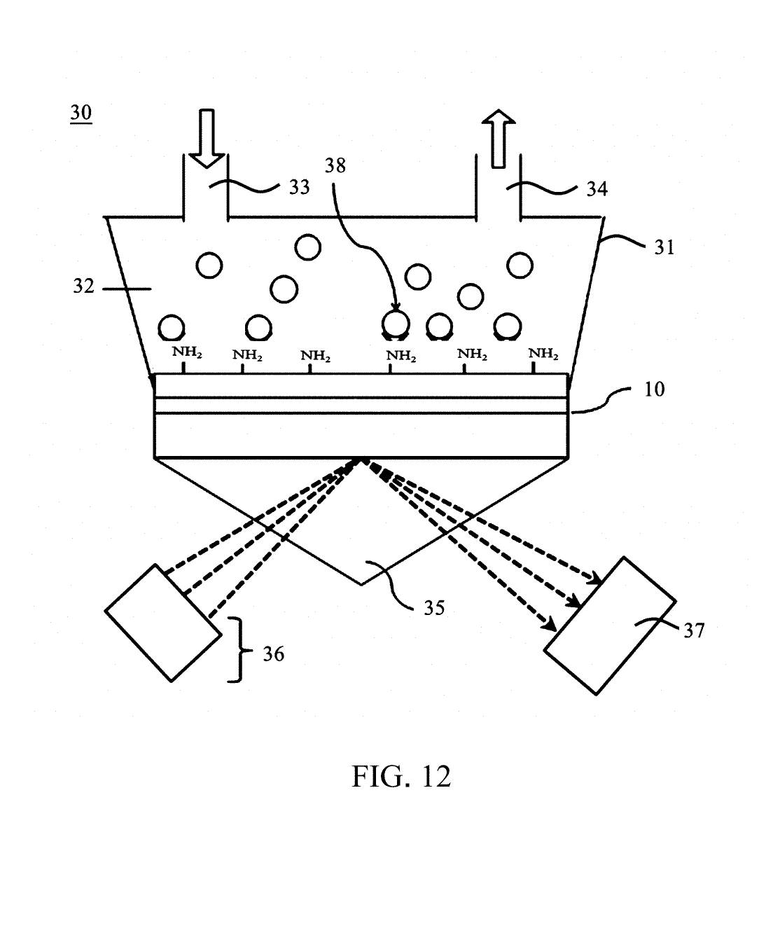

FIG. 12 is a schematic view of a detection device of the present invention. As shown in FIG. 12, a detection device 30 of the present invention comprises: the biosensing chip 10; a casing 31 for covering the biosensing chip 10 and defining a detection cavity 32 jointly with the biosensing chip 10, the casing 31 having an inlet 33 and an outlet 34; a prism 35 disposed below the biosensing chip 10; an emission source 36 disposed below the biosensing chip 10 to emit electromagnetic wave to the biosensing chip 10; and a detector 37 disposed below the biosensing chip 10 to detect electromagnetic wave emitted from the biosensing chip 10 by surface plasmon resonance (SPR).

In an embodiment of the present invention, the emission source 36 in the detection device 30 not only controls factors in variation of an incident angle but also controls the wavelength of the incident light. In this regard, the present invention is not restrictive of the wavelength and magnitude of a light source; for example, the light source is visible light or infrared with a wavelength of 400 nm to 1500 nm and undergoes division and modulation. In a preferred scenario, the light source is a laser beam with a wavelength of 690 nm, whereas the angle of incidence of the incident light is 30° to 80°, preferably 40° to 60°.

Referring to FIG. 12, in practice, a solution which contains target-carrying molecules 38 is introduced into the detection cavity 32 through the inlet 33 and discharged from the detection cavity 32 through the outlet 34. The bonding of the target-carrying molecules 38 and the biosensing chip 10 causes a change in SPR resonant angle. The detector 37 detects the variations in the SPR resonant angle and thus assesses the quantity of the target-carrying molecules 38 in the solution.

The present invention is disclosed above by preferred embodiments. However, persons skilled in the art should understand that the preferred embodiments are illustrative of the present invention only, but shall not be interpreted as restrictive of the scope of the present invention. Hence, all equivalent modifications and replacements made to the aforesaid embodiments shall fall within the scope of the present invention. Accordingly, the legal protection for the present invention shall be defined by the appended claims.

What is claimed is:

1. A biosensing chip, comprising:
a transparent substrate;
a metal layer disposed on the transparent substrate; and
a graphene layer disposed on the metal layer;
wherein the graphene layer is amino (—NH₂)-modified.

2. The biosensing chip of claim 1, wherein the graphene layer comprises at least one of graphene oxide and reduced graphene oxide.

3. The biosensing chip of claim 1, wherein the transparent substrate is one of glass substrate, silicon substrate, and polymer substrate.

4. The biosensing chip of claim 2, wherein the polymer substrate is one of polyethylene (PE) substrate, polyvinyl chloride (PVC) substrate, polyethylene terephthalate (PET) substrate, polydimethylsiloxane (PDMS) substrate, and poly(methyl methacrylate) (PMMA) substrate.

5. The biosensing chip of claim 1, wherein the metal layer comprises one of gold, silver, platinum, palladium, copper, and aluminum.

6. The biosensing chip of claim 1, wherein the metal layer comprises:
a chromium film or a titanium film disposed on the transparent substrate; and
a gold film disposed on the chromium film or the titanium film.

7. The biosensing chip of claim 6, wherein the gold film is of a thickness of 20 nm˜60 nm.

8. The biosensing chip of claim 6, wherein the chromium film or the titanium film is of a thickness of 1 nm˜5 nm.

9. A detection device, comprising:
the biosensing chip of claim 1;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

10. A detection device, comprising:
the biosensing chip of claim 2;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

11. A detection device, comprising:
the biosensing chip of claim 3;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

12. A detection device, comprising:
the biosensing chip of claim 4;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

13. A detection device, comprising:
the biosensing chip of claim 5;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

14. A detection device, comprising:
the biosensing chip of claim 6;
a casing for covering the biosensing chip and defining a detection cavity jointly with the biosensing chip, the casing having an inlet and an outlet;
a prism disposed below the biosensing chip;
an emission source disposed below the biosensing chip to emit electromagnetic wave to the biosensing chip; and
a detector disposed below the biosensing chip to detect electromagnetic wave emitted from the biosensing chip by surface plasmon resonance (SPR).

15. The detection device of claim 9, wherein the emission source emits electromagnetic wave with a wavelength of 400 nm˜1500 nm.

16. The detection device of claim 10, wherein the emission source emits electromagnetic wave with a wavelength of 400 nm˜1500 nm.

17. The detection device of claim 11, wherein the emission source emits electromagnetic wave with a wavelength of 400 nm˜1500 nm.

18. The detection device of claim 12, wherein the emission source emits electromagnetic wave with a wavelength of 400 nm˜1500 nm.

19. The detection device of claim 13, wherein the emission source emits electromagnetic wave with a wavelength of 400 nm˜1500 nm.

20. The detection device of claim 14, wherein the emission source emits electromagnetic wave with a wavelength of 400 nm˜1500 nm.
